(19) United States
(12) Patent Application Publication
(10) Pub. No.: US 2025/0049014 A1
(43) Pub. Date: Feb. 13, 2025

(54) FISHING ROD MANAGEMENT SYSTEM

(71) Applicant: Thomas Blauvelt, Monroeville, IN (US)

(72) Inventor: Thomas Blauvelt, Monroeville, IN (US)

(21) Appl. No.: 18/795,807

(22) Filed: Aug. 6, 2024

Related U.S. Application Data
(60) Provisional application No. 63/518,027, filed on Aug. 7, 2023.

(51) Int. Cl. A01K 97/10

(52) U.S. Cl. CPC A01K 97/10

(57) ABSTRACT

A fishing rod holder assembly for coupling with a fishing platform of a fishing rod management system. The rod holder assembly includes a fishing rod holder device configured for holding a fishing rod and a lid mounting plate. The lid mounting plate attached to the fishing rod holder device. The lid mounting plate includes a flange configured for being held by a lid of the fishing platform so as to mount the fishing rod holder assembly to the fishing platform.

### CROSS REFERENCE TO RELATED APPLICATIONS

This is a non-provisional application based upon U.S. provisional patent application Ser. No. 63/518,027, entitled “FISHING ROD MANAGEMENT SYSTEM”, filed Aug. 7, 2023, which is incorporated herein by reference.

### BACKGROUND OF THE INVENTION

### 1. Field of the Invention

The present invention relates to a fishing rod holding device.

### 2. Description of the Related Art

A fishing rod holder may seem to be a simple device. But a fishing rod holder protects a person's fishing gear as it can hold the fishing rod during transport to the fishing area, but it also holds the rods while waiting for a fish to strike the bait. Trolling with a fishing rod in a holder allows the fisher to relax while watching the rod, waiting for a response indicating a fish strike.

One form of fishing rod holder is a sand spike rod holder, which is simply pushed into the sand. A cylindrical receiver is coupled to the spike into which the fishing rod is inserted in order to hold the fishing rod on a beach.

Another form of a fishing rod holder is one that has a cylindrical receiver that is permanently affixed to part of a boat, some of which have a flush portion to part of the boat structure.

What is needed in the art is a device and method of holding a fishing rod by way of a relocatable and adjustable rod holding device.

### SUMMARY OF THE INVENTION

The present invention relates to fishing platforms, and, more particularly, to fishing rod management systems for fishing platforms.

The present invention in one form is a fishing rod holder assembly for coupling with a fishing platform of a fishing rod management system. The rod holder assembly includes a fishing rod holder device configured for holding a fishing rod and a lid mounting plate. The lid mounting plate attached to the fishing rod holder device. The lid mounting plate includes a flange configured for being held by a lid of the fishing platform so as to mount the fishing rod holder assembly to the fishing platform.

In another form, the present invention is directed to a fishing rod management system having a platform and a container with a lid, a fishing rod holder assembly is coupled to the fishing platform, the rod holder assembly includes a fishing rod holder device configured for holding a fishing rod and a lid mounting plate. The lid mounting plate attached to the fishing rod holder device. The lid mounting plate includes a flange configured for being held by a lid of the fishing platform so as to mount the fishing rod holder assembly to the fishing platform.

An advantage of the present invention is that a fishing rod holder is easily held by an interaction with a lid of a container, and is adjustable. This invention doesn't require a permanent connection to a fishing platform.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates the fishing rod management system of the present invention in situ coupled to a storage container in a boat, with the system holding a fishing rod;

FIG. 2 is a perspective view of the fishing rod management system of FIG. 1;

FIG. 3 is another perspective taken from an opposing view of that shown in FIG. 2, of the fishing rod management system of FIGS. 1 and 2; and

FIG. 4 illustrates a portion of the fishing rod management system of FIGS. 1-3.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

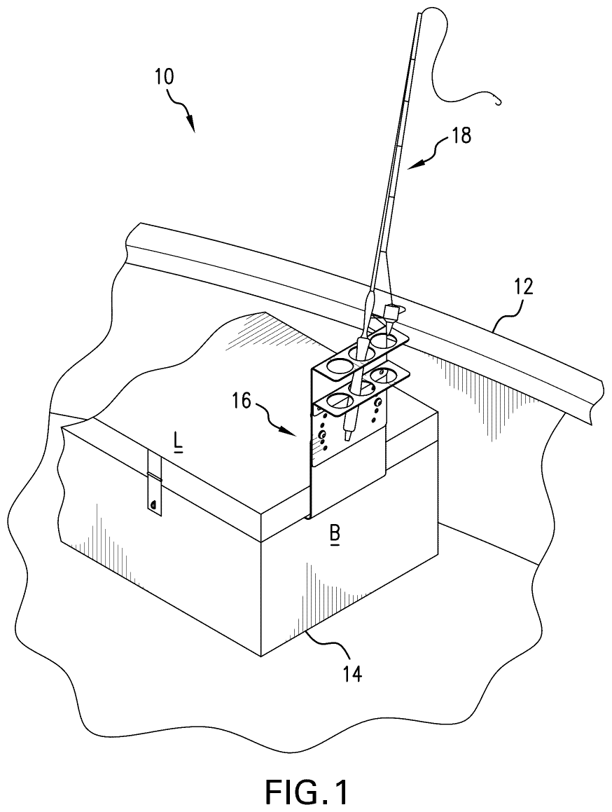

Referring now to FIG. 1, there is illustrated a fishing rod management system 10 according to the present invention. This system 10 originated out of a desire to be able to troll for fish off of a bass boat without the user having to hold a fishing rod. Bass boats, for instance, do not offer rod holding options to be used while trolling, but rod management system solution 10 according to the present invention provides a non-intrusive and highly effective solution. There are a variety of rod holders on the market; however, most require drilling holes to mount the holders to a floor or side of the boat, while others rely on the boat having a railing to clamp onto. As a general rule, boat owners do not like drilling holes in their expensive boats.

System 10 includes a fishing platform 12, having a storage container 14 and a fishing rod holder assembly 16, which couples with fishing platform 12 by way of storage container 14, and is used to hold a fishing rod 18. Fishing platform 12 can be any suitable platform from which a user of rod holder assembly 12 may fish. For example, and not by way of limitation, fishing platform 12 can be any suitable boat 12, such as a bass boat 12; herein, by way of example and not limitation, fishing platform 12 is assumed to bass boat 12. Bass boat 12 is known.

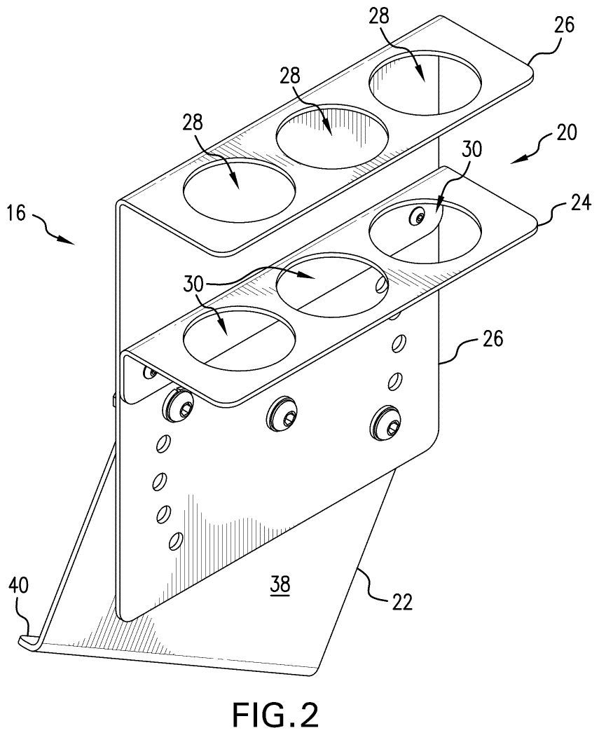

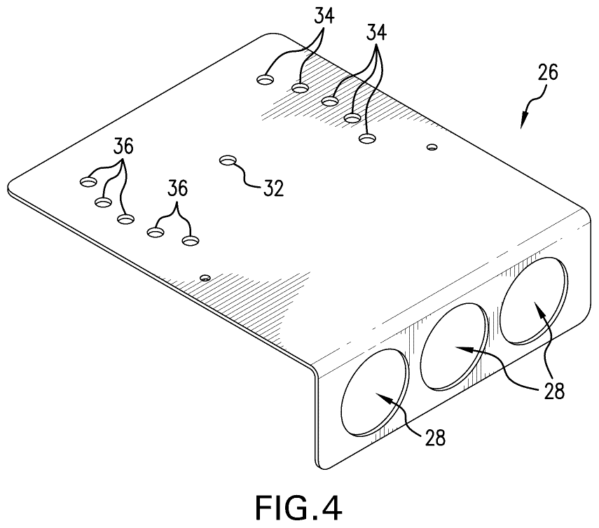

Now, additionally referring to FIGS. 2-4, rod holder assembly 16 includes a fishing rod holder device 20 and a lid mounting plate 22 attached to rod holder device 20. Rod holder device 20 is configured for holding at least one fishing rod 18 and includes a rod holder plate 26 and a rod holder support plate 24 attached to rod holder plate 26, such as by way of any suitable fasteners (such as nuts and bolts). Rod holder plate 26 and rod holder support plate 24 can each be made of any suitable material (such as steel, aluminum, or a polymer) and can be made in any suitable manner (such as stamping and folding). Rod holder plate 26 defines a first array of openings (through-holes) 28 (three such holes being shown in FIG. 1). Rod holder support plate 24 defines a second array of openings (through-holes) 30 which are aligned with openings 28, such that, for example, a center axis of the left-most opening 28 in FIG. 1 is coaxial with a center axis of the left-most opening 30 in FIG. 1. In this way, openings 28 and 30 are configured for selectively receiving therein a handle-end (that is, a butt end) of fishing rod (pole) 18 so as to hold fishing rod 18 therein. That is, a user can place the handle-end of fishing rod 18 in and through selected holes 28, 30 in order to provide different angles and orientations. With three sets of holes 28, 30, three fishing rods can be held by rod holder device 20 simultaneously.

Rod holder plate 26 further defines a center hole 32, holes 34 arranged in a first arc, and holes 36 arranged in a second arc, the first and second arcs opposing one another. Holes 32, 34, 36 are configured for selectively receiving fasteners therein, such as bolts. In this way, rod holder plate 26 can be attached to lid mounting plate 22, such as by way of any suitable fasteners (for example nuts and bolts). When attaching rod holder plate 26 and lid mounting plate 22 to one another, respective ones of holes 34, 36 can be selected by the user so as to orient rod holder plate 26 (and thus rod holder device 20) at a selected angle relative to lid mounting plate 22, with the result that one or more fishing rods in holes 28, 30 can be angled and point in a desired direction.

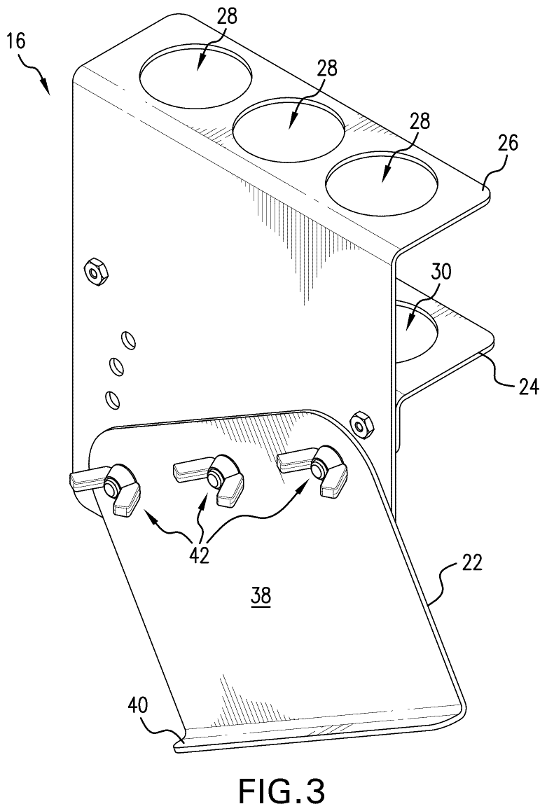

Lid mounting plate 22 is attached to rod holder device 20 and includes a plate section 38 and a flange 40. Lid mounting plate 22 can be made of any suitable material (such as steel, aluminum, or a polymer) and can be made in any suitable manner (such as stamping and folding). Plate section 38 includes a plurality of holes 42 (such as three holes 42), which exist beneath the fasteners, as referred to in FIG. 3. Holes 42 are used to attach plate section 38 to rod holder plate 26 by way of holes 32, 34, 36 and suitable fasteners. Flange 40 (which can be referred to as a bottom flange 40) makes a predetermined angle with plate section 38, such as a right angle. Flange 40 is configured for being held by a lid L of storage container 14 of bass boat 12, so as to mount rod holder assembly 20 to bass boat 12. More specifically, bass boats 12 are known to include one or more such storage compartments 14, such as at the front end of bass boat 12. These storage containers 14 typically include a body B and a lid L. Body B defines a storage area that can be used to store, for example, fishing gear or live fish (forming a live well). Lid L may be opened or closed by a user, to facilitate access therein or to store the items therein. When lid L is closed, lid L may lie substantially horizontally on body B, so as to cover the storage area of storage container 14. To open lid 14, the user lifts lid L up, such that lid L swings about at least one hinge attaching lid L to body B.

Rod holder assembly 20 can be coupled with lid L of the storage container of bass boat 12. This can be accomplished by way of flange 40, which is configured for being held by lid L so as to mount rod holder assembly 20 to bass boat 12. More specifically, in order to mount rod holder assembly 20 to bass boat 12, the user lifts up lid L of storage container 14, places flange 40 (which forms a bottom portion of rod holder assembly 20) on body B (such as, more specifically, on a rubber seal attached to an upwardly facing face of body B, this face surrounding the storage area of container 14), and then simply closes lid L, thereby trapping and securing flange 40 between body B and lid L. In this way, flange 40 fits under lid L at the front of bass boat 12 and is sandwiched between lid L and body B of storage container 14. Plate section 38 then stands substantially upright and thereby rises above lid L, with openings 28, 30 being free, so as to be able to receive at least one fishing rod therein. That is, a user can then selectively insert the handle-end of the fishing rod into holes 28, 30. Holes 28, 30 can be sized so as to hold the fishing rod by way of suspending the fishing rod by way of a friction fit in holes 28 30, or so as to hold the fishing rod by way of supporting the fishing rod as the handle-end of the fishing rod rests on a surface below holes 28, 30.

FIGS. 2 and 3 show perspective views of rod holder assembly 20. More visible here is how rod holder support plate 24 attaches to rod holder plate 26 by way of fasteners, and how plate section 38 attaches to rod holder plate 26 by way of holes 32, 34, 36 and holes 42 by way of fasteners, such as bolts and wing nuts.

In summary, system 10 of the present invention advantageously allows rod holder assembly 20 to be mounted under the storage container lid of boat 12 and advantageously requires no drilling or hardware. Rod holder assembly 20 is easily set up in a matter of seconds and stowed away with ease, removing the possibility of trip hazards while not in use. Assembly 20 differs from existing rod holders which are fastened in place permanently or require tools for removal. Assembly 20 includes adjustable angles to better position the fishing rods for optimal performance and comfort of the user.

Rod holder plate 26 has first and second plurality of holes 34, 36 respectively aligned in a first arc and a second arc. The first arc and the second arc together are two portions of a circular arrangement, centered about hole 32. This puts hole 32 as the circular arrangement of holes 34, 36. Alignment of holes 42 with a selected hole 34, a selected hole 36 and hole 32 allows the shown fasteners to connect lid mounting plate 22 to rod holder plate 26 at a selected angle relative to flange 40 and thus to platform 12.

The lid mounting plate 22 has holes 42 with the outermost holes being spaced at a distance apart equal to the diameter of the circular arrangement of holes 34 and 36. Holes 42 are linearly aligned and this linear alignment is parallel to the alignment of flange 40.

Further, the design of assembly 20 is unique in that it is compatible with most boats, corrosion resistant, versatile, and the ease of use of assembly 20 sets it apart from existing rod management systems on the market. System 20 allows users to operate in both fresh and saltwater conditions, with the ability to fish for multiple species. In addition, the present invention allows users to prepare fishing rods with ease, whether while out on the water or preparing for the next fishing trip. Fishing rod holder 16 has two arrays of holes 28 and 30 with a hole 28, 30 from each array being aligned to receive a fishing rod. Plate 26 has holes arranged in arcs for receiving fasteners to orient holes 42 that are linearly arranged, to orient rod holder 16.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and is claimed in the claims.

What is claimed is:

1. A fishing rod holder assembly for coupling with a fishing platform of a fishing rod management system, the rod holder assembly comprising:
a fishing rod holder device configured for holding a fishing rod; and
a lid mounting plate attached to the fishing rod holder device, the lid mounting plate including a flange configured for being held by a lid of the fishing platform so as to mount the fishing rod holder assembly to the fishing platform.

2. The fishing rod holder assembly according to claim 1, wherein the fishing rod holder device includes a rod holder plate and a rod holder support plate attached to the rod holder plate, the rod holder plate defining a first array of openings, the rod holder support plate defining a second array of openings which are aligned with the first array of openings, the first array of openings and the second array of openings being configured for selectively receiving therein the fishing rod so as to hold the fishing rod therein.

3. The fishing rod holder assembly according to claim 2, wherein the rod holder plate has a first plurality of holes aligned in a first arc and a second plurality of holes aligned in a second arc.

4. The fishing rod holder assembly according to claim 3, wherein the first arc and the second arc together are two portions of a circular arrangement.

5. The fishing rod holder assembly according to claim 4, wherein the rod holder plate has a hole at a center of the circular arrangement.

6. The fishing rod holder assembly according to claim 5, wherein the lid mounting plate has a plurality of holes including a first hole and a second hole spaced at a distance apart equal to a diameter of the circular arrangement.

7. The fishing rod holder assembly according to claim 6, wherein the lid mounting plate additionally has a third hole, with the first hole, the second hole and the third hole are linearly aligned.

8. The fishing rod holder assembly according to claim 7, wherein the linearly aligned holes are parallel to an alignment of the flange.

9. The fishing rod holder assembly according to claim 8, further comprising two fasteners extending through two of the holes in the rod holder plate and two of the holes in the lid mounting plate.

10. A fishing rod management system comprising:
a fishing platform:
a fishing rod holder assembly coupled to the fishing platform, the rod holder assembly comprising:
a fishing rod holder device configured for holding a fishing rod; and
a lid mounting plate attached to the fishing rod holder device, the lid mounting plate including a flange configured for being held by a lid of the fishing platform so as to mount the fishing rod holder assembly to the fishing platform.

11. The fishing rod management system according to claim 10, wherein the fishing rod holder device includes a rod holder plate and a rod holder support plate attached to the rod holder plate, the rod holder plate defining a first array of openings, the rod holder support plate defining a second array of openings which are aligned with the first array of openings, the first array of openings and the second array of openings being configured for selectively receiving therein the fishing rod so as to hold the fishing rod therein.

12. The fishing rod management system according to claim 11, wherein the rod holder plate has a first plurality of holes aligned in a first arc and a second plurality of holes aligned in a second arc.

13. The fishing rod management system according to claim 12, wherein the first arc and the second arc together are two portions of a circular arrangement.

14. The fishing rod management system according to claim 13, wherein the rod holder plate has a hole at a center of the circular arrangement.

15. The fishing rod management system according to claim 14, wherein the lid mounting plate has a plurality of holes including a first hole and a second hole spaced at a distance apart equal to a diameter of the circular arrangement.

16. The fishing rod management system according to claim 15, wherein the lid mounting plate additionally has a third hole, with the first hole, the second hole and the third hole are linearly aligned.

17. The fishing rod management system according to claim 16, wherein the linearly aligned holes are parallel to an alignment of the flange.

18. The fishing rod management system according to claim 17, further comprising two fasteners extending through two of the holes in the rod holder plate and two of the holes in the lid mounting plate.
